(19) United States
(12) Patent Application Publication
(10) Pub. No.: US 2020/0007411 A1
(43) Pub. Date: Jan. 2, 2020

(54) COGNITIVE ROLE-BASED POLICY ASSIGNMENT AND USER INTERFACE MODIFICATION FOR MOBILE ELECTRONIC DEVICES

(71) Applicant: International Business Machines Corporation, Armonk, NY (US)

(72) Inventors: Raphael Arar, Santa Cruz, CA (US); Obinna Brendan Anya, San Jose, CA (US); Sunhwan Lee, San Mateo, CA (US)

(21) Appl. No.: 16/022,490

(22) Filed: Jun. 28, 2018

(51) Int. Cl. H04L 12/24; G06N 99/00

(52) U.S. Cl. CPC H04L 41/22; G06N 99/005

(57) ABSTRACT

One embodiment provides a method comprising detecting presence of a user device in a given environment, performing an assessment of a user of the user device, context and usage, assigning a role to the user device based on the assessment, and modifying user interface behavior of the user device based on a policy corresponding to the role assigned.

The present invention generally relates to mobile electronic devices, and more particularly, to a system and method for cognitive role-based policy assignment and user interface modification for mobile electronic devices.

### BACKGROUND

With the ubiquity of mobile electronic devices (e.g., a tablet, a smart phone, a laptop, etc.) in recent years, usage of software applications for mobile electronic devices (i.e., mobile apps) has become increasingly prevalent across users of mobile electronic devices. The market for mobile apps continues to grow as application developers churn out mobile apps offering different functionalities, productivity features, and/or user experiences. For example, a user may utilize mobile apps to retrieve different types of data such as, but not limited to, music, videos, operating system updates, traffic updates, etc.

### SUMMARY

One embodiment provides a method comprising detecting presence of a user device in a given environment, performing an assessment of a user of the user device, context and usage, assigning a role to the user device based on the assessment, and modifying user interface behavior of the user device based on a policy corresponding to the role assigned.

These and other aspects, features and advantages of the invention will be understood with reference to the drawing figures, and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an example computing architecture for implementing cognitive role-based policy assignment and user interface (UI) modification for user devices, in accordance with an embodiment of the invention;

FIG. 2 illustrates an example implementation of a role assignment system, in accordance with an embodiment of the invention;

FIG. 3 illustrates an example sequence of operations performed by the role assignment system, in accordance with an embodiment of the invention;

FIG. 4 illustrates an example implementation of a policy database, in accordance with an embodiment of the invention;

FIG. 5 is a flowchart of an example process for cognitive role-based policy assignment and UI modification for user devices, in accordance with an embodiment of the invention;

FIG. 6 is a flowchart of an example process for cognitive role-based policy assignment and UI modification for user devices, in accordance with an embodiment of the invention;

FIG. 7 depicts a cloud computing environment according to an embodiment of the present invention;

FIG. 8 depicts a set of functional abstraction layers provided by cloud computing environment according to an embodiment of the present invention; and

FIG. 9 is a high level block diagram showing an information processing system useful for implementing an embodiment of the present invention.

The detailed description explains the preferred embodiments of the invention, together with advantages and features, by way of example with reference to the drawings.

### DETAILED DESCRIPTION

The present invention generally relates to mobile electronic devices, and more particularly, to a system and method for cognitive role-based policy assignment and user interface modification for mobile electronic devices. One embodiment provides a method comprising detecting presence of a user device in a given environment, performing an assessment of a user of the user device, context and usage, assigning a role to the user device based on the assessment, and modifying user interface behavior of the user device based on a policy corresponding to the role assigned.

Mobile electronic device manufacturers, application developers/providers, government agencies and private organizations (e.g., schools, movie theater operators, road safety agents, etc.), and individuals (e.g., parents, etc.) continually seek ways to ensure that use of mobile electronic devices is in accordance with safe and authorized rules and policies in particular circumstances or contexts of use. Typically, such rules are based on roles assigned to users of mobile electronic devices. Conventional approaches for determining and enforcing such rules are largely manual or rule-based. For example, a user may be warned, via his/her mobile electronic device, to refrain from using the mobile electronic device while driving. There is a lack of solutions for automatically modifying configurations of a user interface (UI) of a mobile electronic device based on policies that correspond to dynamically changing roles assigned to users in different contexts/situations.

For expository purposes, the term “environment” as used herein generally refers to a location or context/situation where a user of a mobile electronic device may access. Examples of different environments include, but are not limited to, a place of residence (e.g., a house, an apartment building, etc.), a place of business (e.g., an office building, a shopping mall, etc.), a place of recreation (e.g., a city park, a sports stadium, a concert venue, a movie theater), a personal vehicle (e.g., a car, a motorcycle, a moped, etc.), a commercial vehicle (e.g., a delivery van, etc.), a passenger vehicle (e.g., a bus, a train, etc.), etc.

For expository purposes, the term “user device” as used herein generally refers to a mobile electronic device utilized by a user (i.e., an individual). Examples of different user devices include, but are not limited to, a tablet, a smart phone, a laptop, etc.

For expository purposes, the term “role” as used herein generally refers to a function or part for a user in a particular environment. Examples of different roles may include, but are not limited to, a student in an educational environment (e.g., a school), a teacher in an educational environment (e.g., a school), a patron in an entertainment environment (e.g., a movie theater), an employee in a business environment (e.g., an office), etc.

For expository purposes, the term “policy” as used herein generally refers to a set of rules corresponding to a role, such that management of a behavior of a user assigned the role is in accordance with the set of rules.

For expository purposes, the term “UI behavior” as used herein generally refers to a behavior or configuration of a particular UI on a user device. Examples of a different UIs may include, but are not limited to, a UI of an operating system of a user device, a UI of a mobile app on a user device, etc. The terms “UI behavior” and “UI configuration” may be used interchangeably in this specification.

One embodiment provides a system and a method for cognitively assigning a role to a user based on context, and modifying UI behavior of a user device of the user based on a policy corresponding to the role assigned.

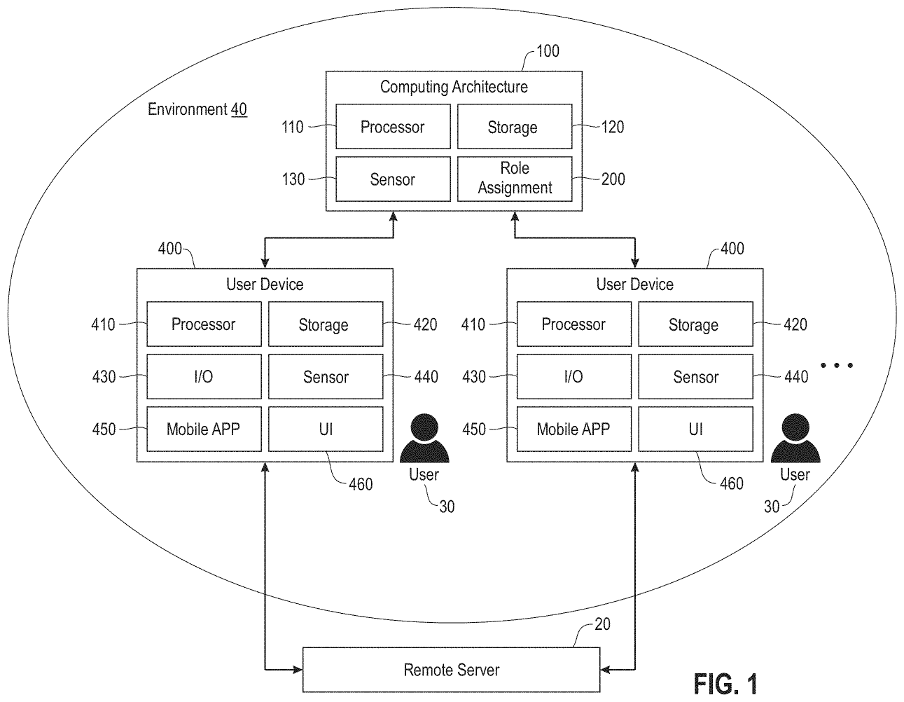

FIG. 1 illustrates an example computing architecture 100 for implementing cognitive role-based policy assignment and user interface modification for user devices, in accordance with an embodiment of the invention. The computing architecture 100 includes computation resources such as, but not limited to, one or more processor units 110 and one or more storage units 120. One or more applications may execute/operate on the computing architecture 100 utilizing the computation resources of the computing architecture 100.

As described in detail later herein, in one embodiment, the applications on the computing architecture 100 include, but are not limited to, a role assignment system 200 configured to perform at least one of the following: (1) detect presence of one or more user devices 400 in a given environment 40, (2) for each user device 400 detected, cognitively assign a role to the user device 400 based on context information and usage information related to the user device 400, and (3) for each user device 400 assigned a role, modify UI behavior of a UI 460 on the user device 400 based on a policy corresponding to the role assigned.

In one embodiment, the computing architecture 100 comprises one or more optional sensor units 130 integrated in or coupled to the computing architecture 100, such as a GPS, an image sensor (e.g., a camera), a microphone, a beacon (e.g., a Bluetooth low energy beacon), a wireless fidelity (Wi-Fi) sensor, etc. In one embodiment, the role assignment system 200 may utilize at least one sensor unit 130 of the computing architecture 100 to detect presence of a user device 400 in the environment 40. In one embodiment, the role assignment system 200 may utilize at least one sensor unit 130 of the computing architecture 100 to collect sensor-based context information related to the user device 400. For example, the role assignment system 200 may utilize a microphone for audio data (e.g., voice recordings), a GPS for location data (e.g., location coordinates), or an image sensor for image/video data (e.g., a live video capture or a photograph of a user device 400 and/or a user 30 of the user device 400, etc.).

In one embodiment, one or more components of the computing architecture 100 may be located at or within proximity of the environment 40 (i.e., local relative to the environment 40). For example, at least one sensor unit 130 of the computing architecture 100 may be local. In another embodiment, one or more components of the computing architecture 100 may be located remotely (i.e., remote relative to the environment 40). For example, one or more components of the role assignment system 200 may be deployed on a remote server 20.

In one embodiment, a user device 400 is equipped with one or more computation resources such as, but not limited to, one or more processor units 410, and one or more storage units 420. One or more applications may execute/operate on a user device 400 utilizing one or more computation resources of the user device 400 such as, but not limited to, one or more software mobile applications (“mobile app”) 450 loaded onto or downloaded to the user device 400, such as a camera application, a social media application, a messaging application, etc. A mobile app 450 on a user device 400 may exchange data with the role assignment system 200. For example, if context information and usage information related to a user device 400 indicate that a user 30 of the user device 400 is driving and a policy corresponding to a role assigned to the user device 400 prohibits texting while driving, the role assignment system 200 may modify UI behavior of the user device 400 by disabling a messaging application on the user device 400.

In one embodiment, a user device 400 is configured to exchange data with the role assignment system 200 and/or a remote server 20 over a connection (e.g., a wireless connection such as a WiFi connection or a cellular data connection, a wired connection, or a combination of the two). For example, a remote server 20 may be an online platform for hosting one or more online services (e.g., an online social media service) and/or distributing one or more mobile apps 450. As another example, a mobile app 450 may be loaded onto or downloaded to a user device 400 from a remote server 20 that maintains and distributes updates for the mobile app 450.

In one embodiment, a user device 400 comprises or more sensor units 440 integrated in or coupled to the user device 400, such as a GPS, an image sensor (e.g., a camera), a microphone, etc. In one embodiment, the role assignment system 200 may utilize at least one sensor unit 440 of a user device 400 to collect sensor-based context information related to the user device 400.

In one embodiment, a user device 400 comprises one or more input/output (I/O) units 430 integrated in or coupled to the user device 400, such as a keyboard, a keypad, a touch interface, a display screen, etc. A user 30 may utilize an I/O module 430 of a user device 400 to configure one or more user preferences/permissions, request data, login or other authentication/verification processes, etc.

In one embodiment, each user device 400 has a unique identifier. A unique identifier of a user device 400 may be, but is not limited to, a mobile electronic device identifier, an Internet Protocol (IP) address, or any other type of identification (e.g., an identification assigned by the role assignment system 200). In one embodiment, a user device 400 is registered with the role assignment system 200 based on a unique identifier of the user device 400.

In one embodiment, the computing architecture 100 is a centralized computing architecture. In another embodiment, the computing architecture 100 is a distributed computing architecture.

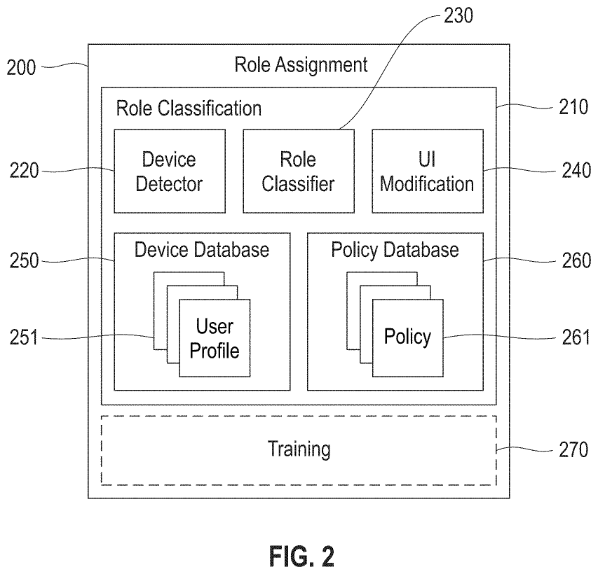

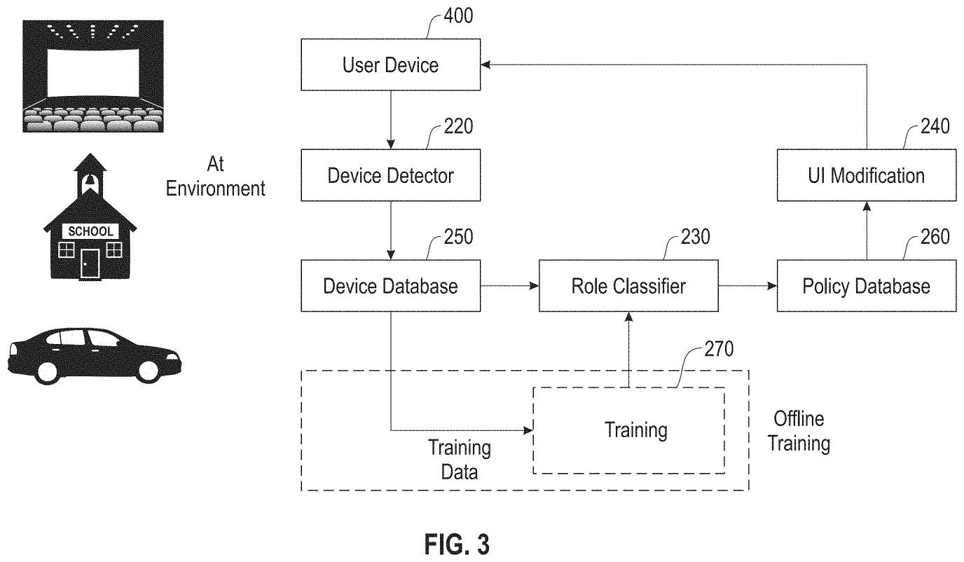

FIG. 2 illustrates an example implementation of a role assignment system 200, in accordance with an embodiment of the invention. FIG. 3 illustrates an example sequence of operations performed by the role assignment system 200, in accordance with an embodiment of the invention. In one embodiment, the role assignment system 200 includes an operating phase which is associated with a role classification system 210. In the operating phase, in one embodiment, the role classification system 210 is configured to: (1) detect presence of a user device 400 in a given environment 40 (e.g., a movie theater, a school, a vehicle, etc.), (2) cognitively assign a role to the user device 400 based on context information and usage information related to the user device 400, and (3) modify UI behavior of the user device 400 based on a policy corresponding to the role assigned.

In one embodiment, the role classification system 210 comprises a device detector unit 220 configured to monitor and detect presence of one or more user devices 400 in the environment 40. For example, the device detector unit 220 may detect a user device 400 in response to the user device 400 entering the environment 40 (e.g., if the environment 40 is a school, when a user 30 of the user device 400 enters the school). In one embodiment, the device detector unit 220 is located at or within proximity of the environment 40 (i.e., local relative to the environment 40).

In one embodiment, the device detector unit 220 is configured to detect presence of a user device 400 in the environment 40 based on sensor-based context information collected utilizing at least one sensor unit 130 or 440.

In one embodiment, the device detector unit 220 is configured to detect presence of a user device 400 in the environment 40 by initiating a discovery process on a local network using conventional and suitable discovery protocols such as UPnP, etc.

In one embodiment, a user device 400 is configured to signify its presence in the environment 40 by transmitting its unique identifier. In one embodiment, the device detector unit 220 may scan for at least one unique identifier of at least one user device 400 that is transmitted wirelessly. For example, a user device 400 in the environment 40 may wirelessly transmit its unique identifier, and the device detector unit 220 may detect presence of the user device 400 in the environment 40 upon receiving/detecting the unique identifier.

For expository purposes, the term “registered user device” as used herein generally refers to a user device 400 that is registered with the role assignment system 200 (i.e., the role assignment system 200 already maintains one or more data records for the user device 400). The terms “registered user device” and “existing user device” may be used interchangeably in this specification. For expository purposes, the term “new user device” as used herein generally refers to a user device 400 that is not registered with the role assignment system 200 (i.e., the role assignment system 200 does not maintain any data records for the user device 400).

In one embodiment, the role classification system 210 comprises a device database 250 maintaining one or more data records for one or more registered user devices. In one embodiment, the device database 250 maintains, for each registered user device, a corresponding user profile 251 comprising context information and usage information related to the registered user device. In one embodiment, context information and usage information related to a registered user device may be collected by the device detector unit 220. For example, the device detector unit 220 may collect context information and usage information related to a registered user device utilizing at least one sensor unit 130 or 440 to capture the context information and usage information.

In one embodiment, context information and usage information related to a registered user device is indicative of one or more user behaviors of a user 30 of the registered user device. For example, context information and usage information related to the registered user device may include, but is not limited to, historical context information and usage information, current context information and usage information, and activity and access pattern information. The historical context information and usage information may include, but is not limited to, spatiotemporal information (e.g., location coordinates, time) indicative of one or more prior locations/positions in the environment 40 that the user 30 has visited/frequented over a pre-determined period of time (e.g., different indoor locations, such as different locations within a classroom the user 30 has sat at if the environment is a school), usage pattern of mobile apps 450 utilized by the user 30 while at the environment 40 over the pre-determined period of time, etc. The current context information and usage information may include, but is not limited to, spatiotemporal information (e.g., location coordinates, time) indicative of a current location/position of the user 30 in the environment 40 and a current time, a current position or direction of the user 30 and/or the registered user device, a current motion of the user 30 (e.g., whether the user 30 is currently running, walking, driving or another type of movement as detected via at least one sensor unit 130 or 440), etc. The activity and access pattern information may include, but is not limited to, frequency at which the user 30 visits/frequents the environment 40 (e.g., if the environment is a gym, number of times the user 30 visits the gym per week), length/duration of time the user 30 spends at the environment 40 (e.g., if the environment is a gym, length of time the user 30 spends at the gym), when the user 30 is driving, types of activities the user 30 performs at the environment 40, public communication data between the user 30 and one or more other individuals in the environment 40, etc.

In one embodiment, a user device 400 may exchange data with one or more sensor units 130 of the environment 40 (e.g., beacons, Wi-Fi sensors, etc.) to triangulate a current location/position of a user 30 of the user device 400 in the environment 40. For example, if an environment is a school and multiple beacons are arranged around a classroom, a user device 400 may communicate with a beacon closest in proximity to the user device 400 to determine a current location/position of a user 30 of the user device 400 within the classroom.

In one embodiment, the device detector unit 230 collects peer data related to a registered user device, such as other context information and usage information related to other registered user devices in the environment 40 (e.g., other registered user devices within proximity the registered user device). For example, if an environment is a school and a user 30 of the registered user device is a student, the peer data may include data related to one or more other students in the same classroom as the user 30.

In one embodiment, context information and usage information related to a registered user device is further indicative of one or more roles previously assigned to the registered user device.

In one embodiment, the role assignment system 200 is configured to determine one or more recurring events involving a user device 40 based on context information and usage information related to the user device 40. For example, the role assignment system 200 may determine when a user 30 of the user device 400 is present at the environment 40 (e.g., if the environment is a school, the user 30 is present during school hours) and/or when the user 30 performs frequent activities (e.g., if the environment is a vehicle, when the user 30 commutes to and from work via the vehicle).

In one embodiment, the pre-determined period of time may be a span of a few days, a few weeks, a few months, or any other duration of time.

In one embodiment, a user profile 251 corresponding to a registered user device is indexed in the device database 250 based on a unique identifier of the user device 400.

In one embodiment, in response to detecting presence of a user device 400 in the environment 40, the device detector unit 220 is configured to authenticate/verify whether the user device 400 is a registered user device or a new user device. If the user device 400 is a registered user device, the device database 250 may be updated to include an updated user profile 251 corresponding to the user device 400 (e.g., updated with current content information and usage information, etc.). A user profile 251 corresponding to a registered user device may be updated each subsequent time the user device 400 is detected in the environment 40. If the user device 400 is a new user device, the user device 400 is registered with the role assignment system 200 and the device database 250 is updated to include a new user profile 251 corresponding to the user device 400.

In one embodiment, the role classification system 210 comprises a role classifier 230 including a trained classifier/learned model for classifying a user device 400 with a role classification label. In one embodiment, the role classifier 230 classifies a user device 400 with a role classification label selected from a set of available role classification labels defined for the environment 40, wherein each role classification label is indicative of a particular role in the environment 40. For example, if the environment 40 is a classroom or school, the set of available role classification labels may include roles such as, but not limited to, teacher, student, teaching assistant, principal, etc. The set of available role classification labels may be defined and refined by one or more administrative users/domain experts (i.e., individuals with expert knowledge on the environment 40). For example, if the environment 40 is a school, the set of available role classification labels may be defined and refined by a school administrator.

In one embodiment, in response to classifying a user device 400 with a role classification label, the role classifier 230 may provide a corresponding accuracy/confidence score (i.e., weight) indicative of likelihood/probability that the user device 400 is classified with a correct role classification label.

In one embodiment, in response to the device detector 220 detecting presence of a user device 400 in the environment 40, the role classifier 230 is configured to: (1) receive a corresponding user profile 251 from the device database 250, if any, (2) perform an assessment of a user 30 of the user device 400 and context information and usage information related to the user device 400, and (3) assign a role to the user device 400 based on the assessment. In one embodiment, the assessment comprises determining whether the user device 400 is an existing user device with no change in context and usage. For example, if the user device 400 is registered with the role assignment system 200 and current context information and usage information related to the user device 400 is substantially similar to information (e.g., historical context information and usage information, usage pattern, activity and access pattern information, etc.) included in the corresponding user profile 251, the role classifier 230 may determine that the user device 400 is an existing user device with no change in context and usage. If the role classifier 230 determines that the user device 400 is an existing user device with no change in context and usage, the role classifier 230 may assume that a role previously/most recently assigned to the user device 400 is still applicable and assign the same role to the user device 400. The corresponding user profile 251 may be updated to include the current context information and usage information and/or data indicative of this latest instance of role assignment.

In one embodiment, if the role classifier 230 determines that the user device 400 is an existing user device with a change in context and usage (i.e., the current context information and usage information related to the user device 400 is substantially different from information included in the corresponding user profile 251), the role classifier 230 may assume that a role previously/most recently assigned to the user device 400 is no longer applicable because of the change. Instead, the role classifier 230 re-classifies the user device 400 with a role classification label based on the current context information and usage information, and assigns the user device 400 with a new role that the role classification label is indicative of The corresponding user profile 251 may be updated to include the current context information and usage information and/or data indicative of this latest instance of role assignment.

In one embodiment, if the role classifier 230 determines that the user device 400 is not an existing user device (i.e., the user device 400 is a new user device instead), the role classifier 230 classifies the user device 400 with a role classification label based on the current context information and usage information, and assigns the user device 400 with a role that the role classification label is indicative of. A new user profile 251 created for the user device 400 may include the current context information and usage information and/or data indicative of this first instance of role assignment.

In one embodiment, the role classification system 210 comprises a policy database 260 maintaining, for each available role classification label that a user device 400 may be classified with, a corresponding policy 261 comprising a set of rules for controlling UI behavior of the user device 400. A set of rules included in a policy 261 may include one or more pre-determined policy factors (e.g., whether usage of a particular mobile app 450 on a user device 400 during a particular context/situation is permissible/authorized or not safe, etc.).

In one embodiment, the role classification system 200 comprises a UI modification unit 240 configured to: (1) receive, from the policy database 260, a policy 261 corresponding to a role assigned to a user device 400, and (2) automatically modify UI behavior of the user device 400 based on the policy 261. In one embodiment, to modify UI behavior of a user device 400, the UI modification unit 240 invokes/triggers one or more actions such as, but not limited to, disabling a mobile app 450 on the user device 400, enforcing conversational interaction mode on the user device 400 when a user 30 of the user device 400 is driving, enforcing silent mode on the user device 400 when the user 30 is in an environment 40 where silence is enforced (e.g., a movie theatre or a place of worship.), etc.

In one embodiment, the role assignment system 200 may invoke/trigger actions affecting UI behavior of a user device 400 only if a user 30 of the user device 400 has set user preferences/permissions to allow such actions.

For expository purposes, the term “known role” as used herein generally refers to a role for a user device 400 that is: (1) validated/verified as accurate/suitable for the user device 400 by an administrative user/domain expert, or (2) automatically assigned to the user device 400 by the role assignment system 200 in response to the role classifier 230 classifying the user device 400 with a role classification label indicative of the role and providing a corresponding high accuracy/confidence score (e.g., a confidence score that is greater than a pre-determined threshold).

In one embodiment, the role assignment system 200 includes an optional training phase which is associated with an optional training system 270. In one embodiment, during the training phase, the training system 270 is configured to train a classifier by: (1) receiving training data including user profiles 251 corresponding to user devices 400 with known roles, (2) mining the training data using one or more supervised machine learning techniques/algorithms to learn different roles in different contexts/situations, (3) determining different contexts/situations and corresponding policy factors based on the training data (e.g., policy factors such as whether it is permissible/authorized or not safe for a user 30 to utilize particular mobile apps 450 on his/her user device 400 during a particular user situation, etc.), and (4) mapping one or more models of user behavior resulting from the learning to the different contexts/situations and corresponding policy factors determined. A trained classifier resulting from the training system 270 may be utilized by the role classifier 230 in the operating phase.

In one embodiment, the training phase may take place offline (i.e., not on the computing architecture 100). For example, in one embodiment, the training phase may take place utilizing a remote server 20.

In one embodiment, when collecting context information and usage information related a registered user device, the device detector unit 220 may apply a moving time window to the information collected to maintain recency of the information collected. A trained classifier/model utilized by the role classifier 230 may be re-trained/updated based on recent information collected.

In one embodiment, the role assignment system 200 may notify an administrative user/domain expert and request refinement of a set of available role classification labels if the role classifier 230 provides one or more low accuracy/confidence scores (e.g., confidence scores that are less than a pre-determined threshold). A trained classifier/model utilized by the role classifier 230 may be re-trained/updated based on the refinement.

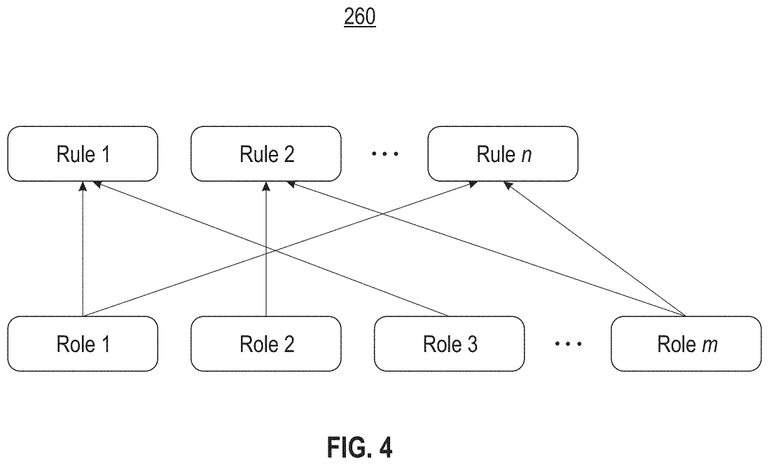

FIG. 4 illustrates an example implementation of a policy database 260, in accordance with an embodiment of the invention. In one embodiment, each available role classification label that a user device 400 may be classified with is mapped to one or more rules. For example, assume a set of available role classification labels include a first role classification label (ROLE 1), a second role classification label (ROLE 2), . . . , and a m^{th} role classification label (ROLE m), wherein m is a positive integer. Assume a set of available rules that a role classification label may be mapped to include a first rule (RULE 1), a second rule (RULE 2), . . . , and a n^{th} rule (RULE n), wherein n is a positive integer. As shown in FIG. 4, the first role classification label (ROLE 1) is mapped to the first rule (RULE 1) and the n^{th} rule (RULE n), the second role classification label (ROLE 2) is mapped to the second rule (RULE 2), the third role classification label (ROLE 3) is mapped to the first rule (RULE 1), . . . , and the m^{th} role classification label (ROLE m) is mapped to the second rule (RULE 2) and the n^{th} rule (RULE n).

Each rule that a role classification label is mapped to is included in a policy corresponding to a role indicative of the role classification label. For example, a first policy corresponding to a first role indicative of the first role classification label (ROLE 1) includes the first rule (RULE 1) and the n^{th} rule (RULE n), a second policy corresponding to a second role indicative of the second role classification label (ROLE 2) includes the second rule (RULE 2), a third policy corresponding to a third role indicative of the third role classification label (ROLE 3) includes the third rule (RULE 3), . . . , and a m^{th} policy corresponding to a m^{th} role indicative of the m^{th} role classification label (ROLE m) includes the first rule (RULE 1) and the n^{th} rule (RULE n).

The role assignment system 200 may provide different application uses. For example, if a given environment 40 is a vehicle, a road safety agent may utilize the role assignment system 200 to assign a role of driver to a user device 400 in response to determining a user 30 of the user device 400 is driving (e.g., based on a position of the user 30 relative to a steering wheel of the vehicle as captured by at least one sensor unit 130 or 440), and automatically modify UI behavior of the user device 400 based on a policy corresponding to the role assigned (e.g., enforcing conversational interaction mode on the user device 400).

As another example, if a given environment 40 is a school, the role assignment system 200 may assign a role to a user device 400 based at least in part on a current location/position of a user 30 of the user device 400 in a classroom and/or a current time. For example, a school administrator may utilize the role assignment system 200 to assign a role of teacher if the user 30 is at the front/head of the classroom, assign a role of student if the user 30 is at the middle of the classroom, assign a role of teaching assistant if the user 30 is next to a teacher's desk at the head of the classroom, etc. If the current time is during school hours, the role assignment system 200 automatically modifies UI behavior of the user device 400 based on a policy corresponding to the role assigned. For example, the role assignment system 200 may disable any mobile app 450 on the user device 400 that may distract the user 30 from learning if the role of student is assigned; the role assignment system 200 may enable each disabled mobile app 450 once the current time is outside school hours.

As yet another example, if a given environment 40 is a public place where silence is enforced (e.g., a movie theater or a place of worship), the role assignment system 200 may assign a role to a user device 400 based at least in part on a current location/position of a user 30 of the user device 400 in the public place and/or a current time, and automatically modify UI behavior of the user device 400 based on a policy corresponding to the role assigned. For example, an operator of a movie theater may utilize the role assignment system 200 to assign a role of patron to a user device 400 if a user 30 of the user device 400 is located/positioned among seats of the movie theater. If the current time is substantially close to a start time of a movie playing at the movie theater, the role assignment system 200 automatically enforces silent mode on the user device 400 and maintains the silent mode during the duration of the movie; the role assignment system 200 lifts the silent mode on the user device 400 once the movie ends.

As yet another example, the role assignment system 200 may assign a new role to a registered user device in response to detecting a change in context and usage related to the registered user device. For example, assume a given environment 40 is a school and the registered user device is assigned a role of student. Contextual information and usage information related to the registered user device may include a current location/position of a user 30 of the registered user device within a classroom (e.g., as determined via one or more beacons, etc.), a current time, and peer data related to other students in the classroom. Through prolonged usage during normal class times (e.g., verified using time and peer-to-peer communication to determine a class is in session), the role assignment system 200 detects changes in context and usage, such as the user 30 has been consistently next to a teacher's desk at the head of the classroom, and there are frequent collaborations between the user 30 and a teacher on lesson plans based on text-mining of public communication data collected between the user 30 and the teacher. Based on the changes detected, the role assignment system 200 may propose changing the role assigned to the registered user device from the role of student to a role of teaching assistant (e.g., a trained classifier/model utilized by the role classifier may add more weight to a role classification label representing the role of the teaching assistant as a result of the changes detected). The role assignment system 200 may verify the proposed change in roles with an administrative user (e.g., a school administrator such as a teacher) before assigning the new role of teaching assistant to the registered user device. If the administrative user validates/verifies the proposed change in roles, the role assignment system 200 assigns the new role of teaching assistant to the registered user device, and modifies UI behavior of the registered user device based on a policy corresponding to the new role assigned.

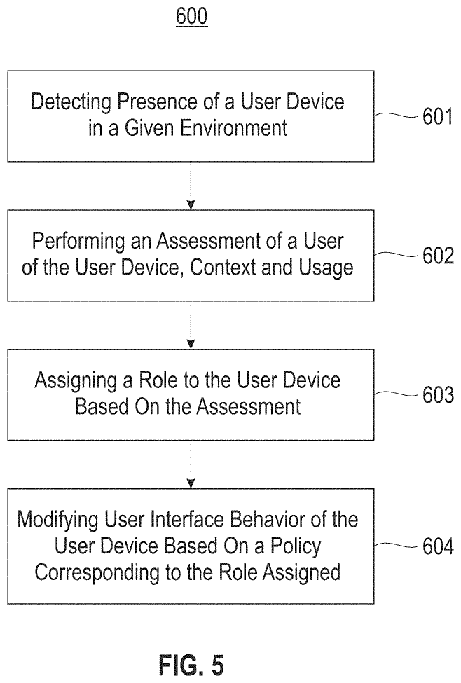

FIG. 5 is a flowchart of an example process 600 for cognitive role-based policy assignment and UI modification for user devices, in accordance with an embodiment of the invention. Process block 601 includes detecting presence of a user device in a given environment. Process block 602 includes performing an assessment of a user of the user device, context and usage. Process block 603 includes assigning a role to the user device based on the assessment. Process block 604 includes modifying user interface behavior of the user device based on a policy corresponding to the role assigned.

In one embodiment, process blocks 601-604 may be performed by one or more components of the role assignment system 200, such as the device detector unit 220, the role classifier 230 and/or the UI modification unit 240.

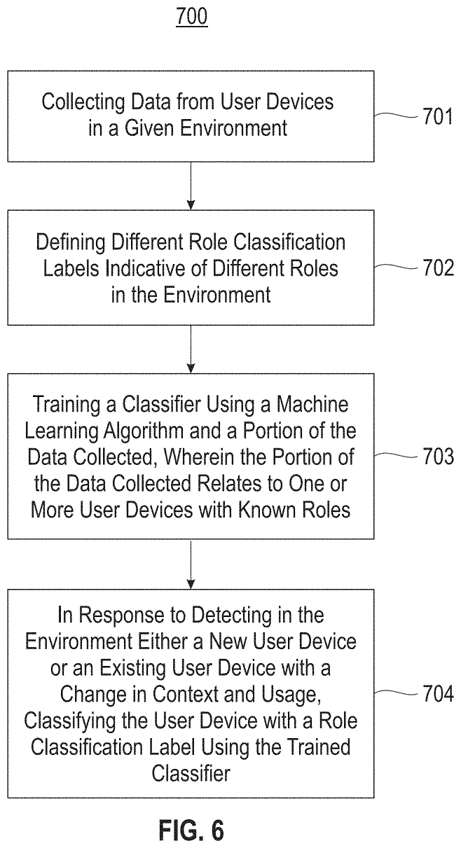

FIG. 6 is a flowchart of an example process 700 for cognitive role-based policy assignment and UI modification for user devices, in accordance with an embodiment of the invention. Process block 701 includes collecting data from user devices in a given environment. Process block 702 includes defining different role classification labels indicative of different roles in the environment. Process block 703 includes training a classifier using a machine learning algorithm and a portion of the data collected, wherein the portion of the data collected relates to one or more user devices with known roles. Process block 704 includes, in response to detecting in the environment either a new user device or an existing user device with a change in context and usage, classifying the user device with a role classification label using the trained classifier.

In one embodiment, process blocks 701-704 may be performed by one or more components of the role assignment system 200, such as the training system 270.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure that includes a network of interconnected nodes.

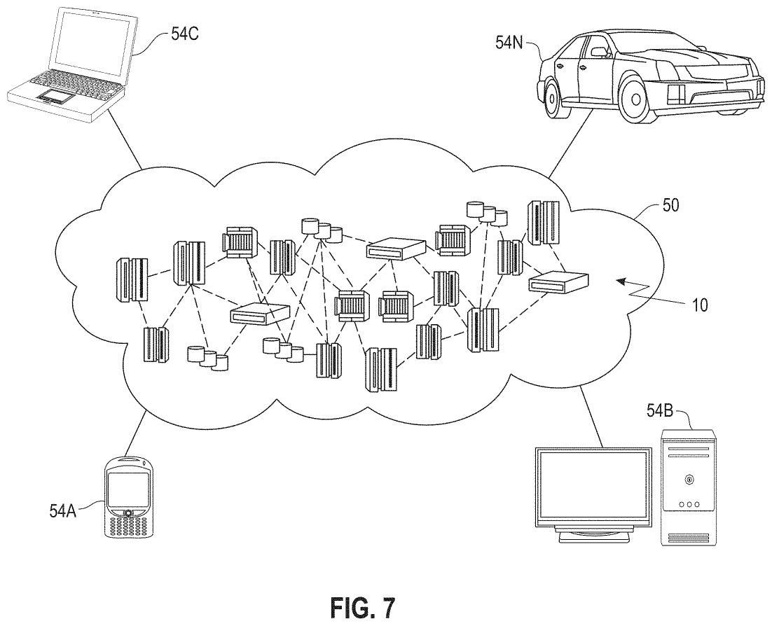

FIG. 7 depicts a cloud computing environment 40 according to an embodiment of the present invention. As shown, cloud computing environment 40 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 40 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 40 can communicate with any type of computerized device over any type of network and/or network addressable connection (e.g., using a web browser).

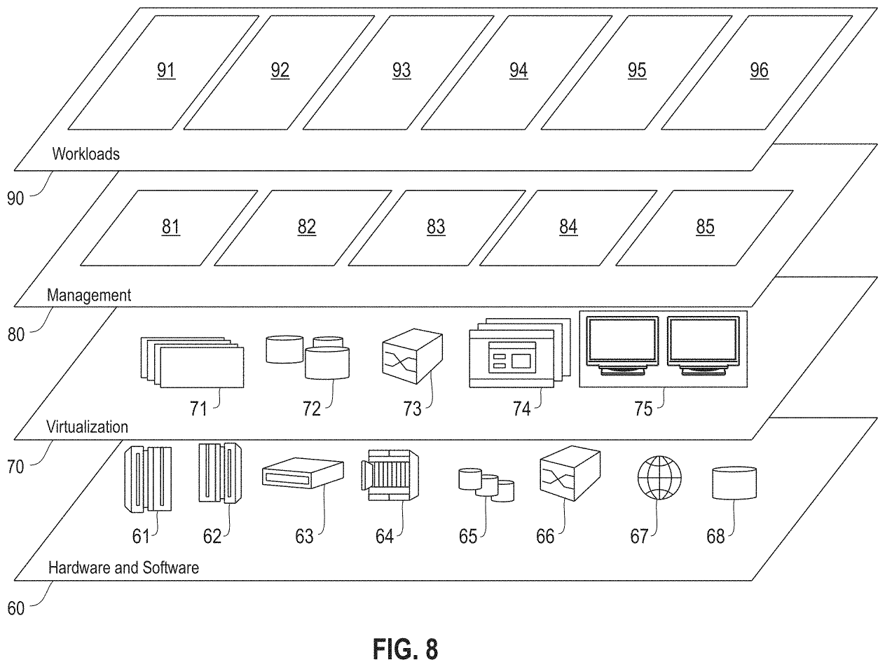

FIG. 8 depicts a set of functional abstraction layers provided by cloud computing environment 40 according to an embodiment of the present invention. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and cognitive role-based policy assignment and UI modification for user devices 96 (e.g., the role assignment system 200).

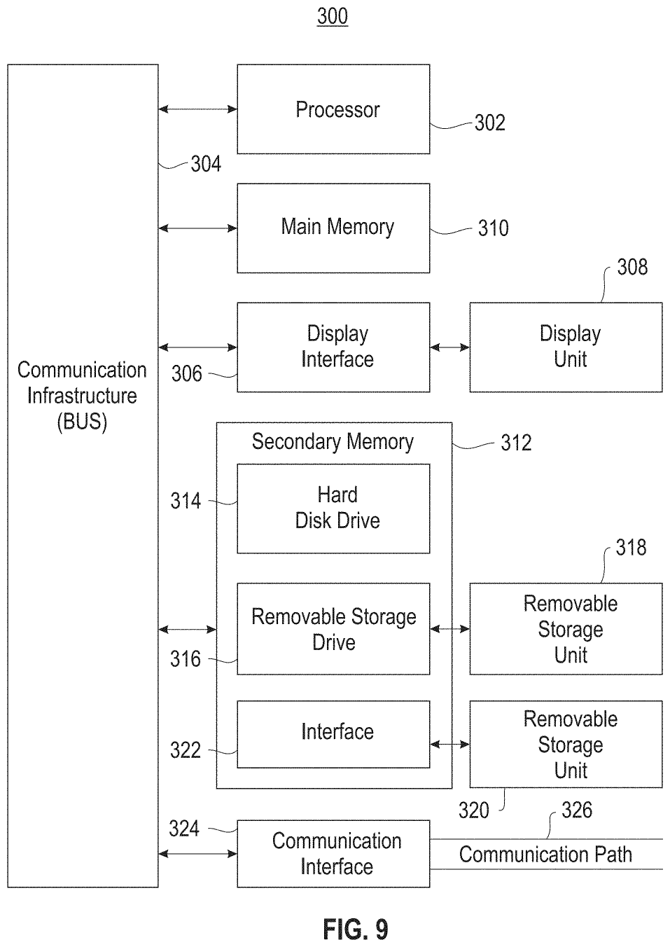

FIG. 9 is a high level block diagram showing an information processing system 300 useful for implementing one embodiment of the invention. The computer system includes one or more processors, such as processor 302. The processor 302 is connected to a communication infrastructure 304 (e.g., a communications bus, cross-over bar, or network).

The computer system can include a display interface 306 that forwards graphics, text, and other data from the voice communication infrastructure 304 (or from a frame buffer not shown) for display on a display unit 308. The computer system also includes a main memory 310, preferably random access memory (RAM), and may also include a secondary memory 312. The secondary memory 312 may include, for example, a hard disk drive 314 and/or a removable storage drive 316, representing, for example, a floppy disk drive, a magnetic tape drive, or an optical disk drive. The removable storage drive 316 reads from and/or writes to a removable storage unit 318 in a manner well known to those having ordinary skill in the art. Removable storage unit 318 represents, for example, a floppy disk, a compact disc, a magnetic tape, or an optical disk, etc. which is read by and written to by removable storage drive 316. As will be appreciated, the removable storage unit 318 includes a computer readable medium having stored therein computer software and/or data.

In alternative embodiments, the secondary memory 312 may include other similar means for allowing computer programs or other instructions to be loaded into the computer system. Such means may include, for example, a removable storage unit 320 and an interface 322. Examples of such means may include a program package and package interface (such as that found in video game devices), a removable memory chip (such as an EPROM, or PROM) and associated socket, and other removable storage units 320 and interfaces 322, which allows software and data to be transferred from the removable storage unit 320 to the computer system.

The computer system may also include a communication interface 324. Communication interface 324 allows software and data to be transferred between the computer system and external devices. Examples of communication interface 324 may include a modem, a network interface (such as an Ethernet card), a communication port, or a PCMCIA slot and card, etc. Software and data transferred via communication interface 324 are in the form of signals which may be, for example, electronic, electromagnetic, optical, or other signals capable of being received by communication interface 324. These signals are provided to communication interface 324 via a communication path (i.e., channel) 326. This communication path 326 carries signals and may be implemented using wire or cable, fiber optics, a phone line, a cellular phone link, an RF link, and/or other communication channels.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

From the above description, it can be seen that the present invention provides a system, computer program product, and method for implementing the embodiments of the invention. The present invention further provides a non-transitory computer-useable storage medium for implementing the embodiments of the invention. The non-transitory computer-useable storage medium has a computer-readable program, wherein the program upon being processed on a computer causes the computer to implement the steps of the present invention according to the embodiments described herein. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
detecting presence of a user device in a given environment;
performing an assessment of a user of the user device, context and usage;
assigning a role to the user device based on the assessment; and
modifying user interface behavior of the user device based on a policy corresponding to the role assigned.

2. The method of claim 1, wherein the user device is a mobile electronic device.

3. The method of claim 1, wherein the context and usage comprises at least one of historical context information and usage information related to the user device, current context information and usage information related to the user device, and activity and access pattern information related to the user device.

4. The method of claim 1, further comprising:
training a classifier, wherein the classifier is trained to classify the user device with a role classification label based on the context and usage, and the role classification label is selected from a set of available role classification labels representing different roles in the given environment.

5. The method of claim 4, wherein training a classifier comprises:
collecting data from multiple user devices in the given environment;
applying a moving time window to the data collected;
defining the set of available role classification labels; and
training the classifier using a machine learning algorithm and a portion of the data collected, wherein the portion of the data collected relates to one or more user devices with known roles.

6. The method of claim 5, wherein training a classifier further comprises:
refining the set of available role classification labels; and
re-training the classifier to classify the user device with a role classification label selected from the refined set of available role classification labels.

7. The method of claim 1, wherein performing an assessment of a user of the user device, context and usage comprises:
determining that a prior role assigned to the user device is currently applicable to the user device in response to determining the user device is an existing user device and there is no change in the context and usage, wherein the role assigned to the user device is the prior role.

8. The method of claim 1, wherein performing an assessment of a user of the user device, context and usage comprises:
utilizing a classifier to classify the user device with a role classification label based on the context and usage in response to determining the user device is an existing user device and there is a change in the context and usage, wherein the role assigned to the user device is represented by the role classification label.

9. The method of claim 1, wherein performing an assessment of a user of the user device, context and usage comprises:
utilizing a classifier to classify the user device with a role classification label based on the context and usage in response to determining the user device is a new user device, wherein the role assigned to the user device is represented by the role classification label.

10. A system comprising:
at least one processor; and
a non-transitory processor-readable memory device storing instructions that when executed by the at least one processor causes the at least one processor to perform operations including:
detecting presence of a user device in a given environment;
performing an assessment of a user of the user device, context and usage;
assigning a role to the user device based on the assessment; and
modifying user interface behavior of the user device based on a policy corresponding to the role assigned.

11. The system of claim 10, wherein the user device is a mobile electronic device.

12. The system of claim 10, wherein the context and usage comprises at least one of historical context information and usage information related to the user device, current context information and usage information related to the user device, and activity and access pattern information related to the user device.

13. The system of claim 10, further comprising:
training a classifier, wherein the classifier is trained to classify the user device with a role classification label based on the context and usage, and the role classification label is selected from a set of available role classification labels representing different roles in the given environment.

14. The system of claim 10, wherein training a classifier comprises:
collecting data from multiple user devices in the given environment;
applying a moving time window to the data collected;
defining the set of available role classification labels; and
training the classifier using a machine learning algorithm and a portion of the data collected, wherein the portion of the data collected relates to one or more user devices with known roles.

15. The system of claim 14, wherein training a classifier further comprises:
refining the set of available role classification labels; and
re-training the classifier to classify the user device with a role classification label selected from the refined set of available role classification labels.

16. The system of claim 10, wherein performing an assessment of a user of the user device, context and usage comprises:
determining that a prior role assigned to the user device is currently applicable to the user device in response to determining the user device is an existing user device and there is no change in the context and usage, wherein the role assigned to the user device is the prior role.

17. The system of claim 10, wherein performing an assessment of a user of the user device, context and usage comprises:
utilizing a classifier to classify the user device with a role classification label based on the context and usage in response to determining the user device is an existing user device and there is a change in the context and usage, wherein the role assigned to the user device is represented by the role classification label.

18. The system of claim 10, wherein performing an assessment of a user of the user device, context and usage comprises:
utilizing a classifier to classify the user device with a role classification label based on the context and usage in response to determining the user device is a new user device, wherein the role assigned to the user device is represented by the role classification label.

19. A computer program product comprising a computer-readable hardware storage medium having program code embodied therewith, the program code being executable by a computer to implement a method comprising:
detecting presence of a user device in a given environment;
performing an assessment of a user of the user device, context and usage;
assigning a role to the user device based on the assessment; and
modifying user interface behavior of the user device based on a policy corresponding to the role assigned.

20. The computer program product of claim 19, wherein the user device is a mobile electronic device.
